(19) United States
(12) Patent Application Publication
(10) Pub. No.: US 2003/0026202 A1
(43) Pub. Date: Feb. 6, 2003

(54) Communications network with redundancy between peripheral units

(76) Inventor: Benedikt Aschermann, Wuppertal (DE)

Correspondence Address: NIXON & VANDERHYE P.C., 8th Floor, 1100 North Glebe Road, Arlington, VA, 22201, US

(21) Appl. No.: 09/920,333

(22) Filed: Aug. 2, 2001

(51) Int. Cl. H04J 1/16

(52) U.S. Cl. 370/216; 370/252

(57) ABSTRACT

Redundancy is established over a radio link (RL) between peripheral units (28) of a communications network (20). The communications network includes a central unit (26) which is connected by a first link (L_{A}) to a first peripheral unit (28_{A}) and by a second link (L_{B}) to a second peripheral unit (28_{B}). The radio link connects the first peripheral unit and the second peripheral unit. Redundancy is realized by providing communication between the central unit and the second peripheral unit over the radio link upon failure of the second link. In one illustrated example implementation, the communications network is a radio access network of a telecommunications system, with the central unit being a radio network control (RNC) node and the first peripheral unit and the second peripheral unit being differing base stations of the radio access network. In another illustrated example embodiment, the central unit, the first peripheral unit, and the second peripheral unit comprise portions of a distributed radio base station node of a radio access telecommunications network. For example, the central unit comprises data processing and control functions of the distributed radio base station node, while the first peripheral unit and the second peripheral unit each comprises a transceiver of the distributed radio base station node. In a first mode of operation, traffic and control information which otherwise would be carried over the second link between the central unit and the second peripheral unit is rerouted to the radio link and the first link. In a second mode of operation, rather than rerouting the entire traffic and control information, certain control information is carried between the central unit and the second peripheral unit over the radio link and the first link.

### BACKGROUND

1. Field of the Invention

The present invention pertains to communications networks, and particularly to redundancy for links utilized in communications networks.

2. Related Art and Other Considerations

Networks such as communication networks have different types of network entities or nodes. A general distinction can be made between internal nodes which do not have a direct interface to the user of the network and terminal nodes which do interface with the user. Such an internal node is sometimes referred to as controller, switch, hub, or central unit. A terminal node is frequently referred to as an access node, remote unit, terminal, peripheral, or the like. As used herein, the term “peripheral” will generally be used generically for the types of network units/nodes which have a direct interface with or to the user, while the term “central unit” will generally be used generically for internal network units/nodes.

Nodes/units of communication networks are typically connected by one or more links. For example, each peripheral node of a network is typically connected by at least one link to the central unit. In a communications network having a star topology, for instance, the central unit is connected to each peripheral node by a physical link. The physical link typically encompasses both traffic and control functionalities (e.g., may comprise a traffic link and a control link).

Reliability is normally a concern in communication networks, so frequently there is some provision for redundancy on the landline or wired links connecting two or more network nodes. In some situations redundancy can be realized by utilizing plural such links rather than a single link between network nodes. In the case of the star topology network mentioned above, for example, one or more of the peripheral nodes can be connected by plural links rather than by a single link to the central unit. See, for example, U.S. Pat. No. 6,128,277 and European Patent document EP 1019841.

Redundancy can also be applied in the context of an Ethernet bus system, as described in German Patent Document DE 19513316 which uses a multiplexer between the backbone and the peripheral node. No provision is made for redundancy in the stub from the backbone to the peripheral node. Internal redundancy in a central unit-type node is described in U.S. Pat. No. 5,027,342 and European Patent document EP 396084. An automatic redundancy scheme between peer nodes in an interconnected computer network is described in European Patent document EP 939560, but assumes that there is more than one preinstalled link between the communicating peer nodes. A communication network with distributed nodes having a mesh like backbone for redundancy is proposed in U.S. Pat. No. 5,761,619 and European Patent document EP 815697.

In some instances it is not feasible or economical to provide redundancy merely by setting up additional landline or wired links between nodes, e.g., between a central unit and peripheral nodes of the communications network. A significant drawback to the multiple link approach is the cost related to the establishment of additional landline or wired links. Use of multiple such links appears particularly in appropriate and cost prohibitive in certain telecommunications systems which have a pure star topology network with remote peripheral nodes (e.g., base stations) being located several kilometers from a central unit [e.g., a radio network controller (RNC) node].

What is needed, therefore, and an object of the present invention, is a scheme which provides redundancy without requiring additional landline or wired links between nodes.

### BRIEF SUMMARY OF THE INVENTION

Redundancy is established over a radio link between peripheral units of a communications network. The communications network includes a central unit which is connected by a first link to a first peripheral unit and by a second link to a second peripheral unit. The radio link connects the first peripheral unit and the second peripheral unit. Redundancy is realized by providing communication between the central unit and the second peripheral unit over the radio link upon failure of the second link.

In one illustrated example implementation, the communications network is a radio access network of a telecommunications system, with the central unit being a radio network control (RNC) node and the first peripheral unit and the second peripheral unit being differing base stations of the radio access network. In another illustrated example embodiment, the central unit, the first peripheral unit, and the second peripheral unit comprise portions of a distributed radio base station node of a radio access telecommunications network. For example, the central unit comprises data processing and control functions of the distributed radio base station node, while the first peripheral unit and the second peripheral unit each comprises a transceiver of the distributed radio base station node.

In a first mode of operation, traffic which otherwise would be carried over the second link between the central unit and the second peripheral unit is rerouted to the radio link and the first link. This first mode assumes that the radio link and the first link have sufficient capacity to carry the rerouted traffic.

In a second mode of operation, rather than rerouting the entire traffic, certain control information is carried between the central unit and the second peripheral unit over the radio link and the first link. In an illustrated example scenario, this control information concerns either the second link (e.g., the status of the second link) or concerns the second peripheral unit itself. For example, the control information can be fault localization information concerning failure of the second link.

In one embodiment, the central unit is involved in the redundancy process by, e.g., determining whether traffic and/or control information is to be rerouted from the second link to the first link. In another embodiment, such determination is entrusted to the first peripheral unit (e.g., the peripheral unit through which the traffic and/or control information is to be rerouted).

The first peripheral unit and the second peripheral unit are physically separated by a sufficiently small geographical separation distance which makes reasonable the employment of the radio link. The geographical separation distance is preferably in a range of from about one meter to several kilometers. One technology suitable for establishment of the radio link (in the lower end of the range) is the Bluetooth™ wireless communication technology.

The invention concerns not only the communications network itself, but also peripheral units employed therein, as well as methods for operating the communication system in accordance with the principles of the present invention.

### BRIEF DESCRIPTION OF THE DRAWINGS

The foregoing and other objects, features, and advantages of the invention will be apparent from the following more particular description of preferred embodiments as illustrated in the accompanying drawings in which reference characters refer to the same parts throughout the various views. The drawings are not necessarily to scale, emphasis instead being placed upon illustrating the principles of the invention.

FIG. 1 is a diagrammatic view of an example, representation communications system depicting an embodiment of a redundancy capability according to the present invention.

FIG. 1A is a diagrammatic view showing example constituent elements of a redundancy over radio link function according to one embodiment of the present invention.

FIG. 1B is a diagrammatic view showing example constituent elements of a redundancy over radio link function according to another embodiment of the present invention wherein a central unit is substantially involved in performing at least some redundancy steps.

FIG. 2A is a diagrammatic view showing an example redundancy scenario wherein a redundant radio link between peer peripheral units carries substantially the entire traffic of a failed landline link.

FIG. 2B is a diagrammatic view showing an example redundancy scenario wherein a redundant radio link between peer peripheral units substantially carries control information regarding a failed landline link or one of the peer peripheral units.

FIG. 3 is a flowchart showing basic steps preformed by a redundancy over radio link function according to an embodiment of the present invention, and wherein redundancy steps are performed primarily by peer peripheral units.

FIG. 4 is a flowchart showing basic steps preformed by a redundancy over radio link function according to another embodiment of the present invention, and wherein a central unit is substantially involved in performing at least some redundancy steps.

FIG. 5 is diagrammatic view of example mobile communications system in which the present invention may be advantageously employed.

FIG. 6 is a simplified function block diagram of a portion of a UMTS Terrestrial Radio Access Network, including a user equipment unit (UE) station; a radio network controller; and a base station.

FIG. 7 is a diagrammatic view showing an example utilization of a redundancy over radio link function of FIG. 2 in context of the network of FIG. 2.

FIG. 8 is a schematic view of an example base station node in accordance with one embodiment of the invention.

FIG. 9 is a schematic view of an example implementation of the present invention in which the central unit, the first peripheral unit, and the second peripheral unit comprise portions of a distributed radio base station node of a radio access telecommunications network.

### DETAILED DESCRIPTION OF THE DRAWINGS

In the following description, for purposes of explanation and not limitation, specific details are set forth such as particular architectures, interfaces, techniques, etc. in order to provide a thorough understanding of the present invention. However, it will be apparent to those skilled in the art that the present invention may be practiced in other embodiments that depart from these specific details. In other instances, detailed descriptions of well known devices, circuits, and methods are omitted so as not to obscure the description of the present invention with unnecessary detail. Those skilled in the art will appreciate that the functions may be implemented using individual hardware circuits, using software functioning in conjunction with a suitably programmed digital microprocessor or general purpose computer, using an application specific integrated circuit (ASIC), and/or using one or more digital signal processors (DSPs).

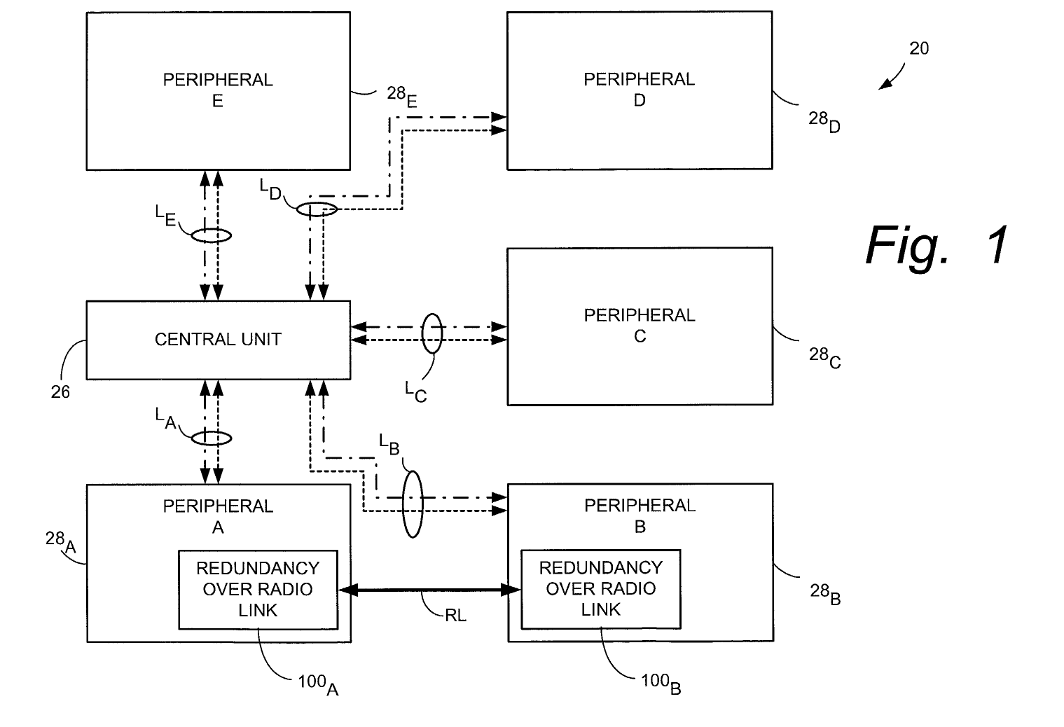

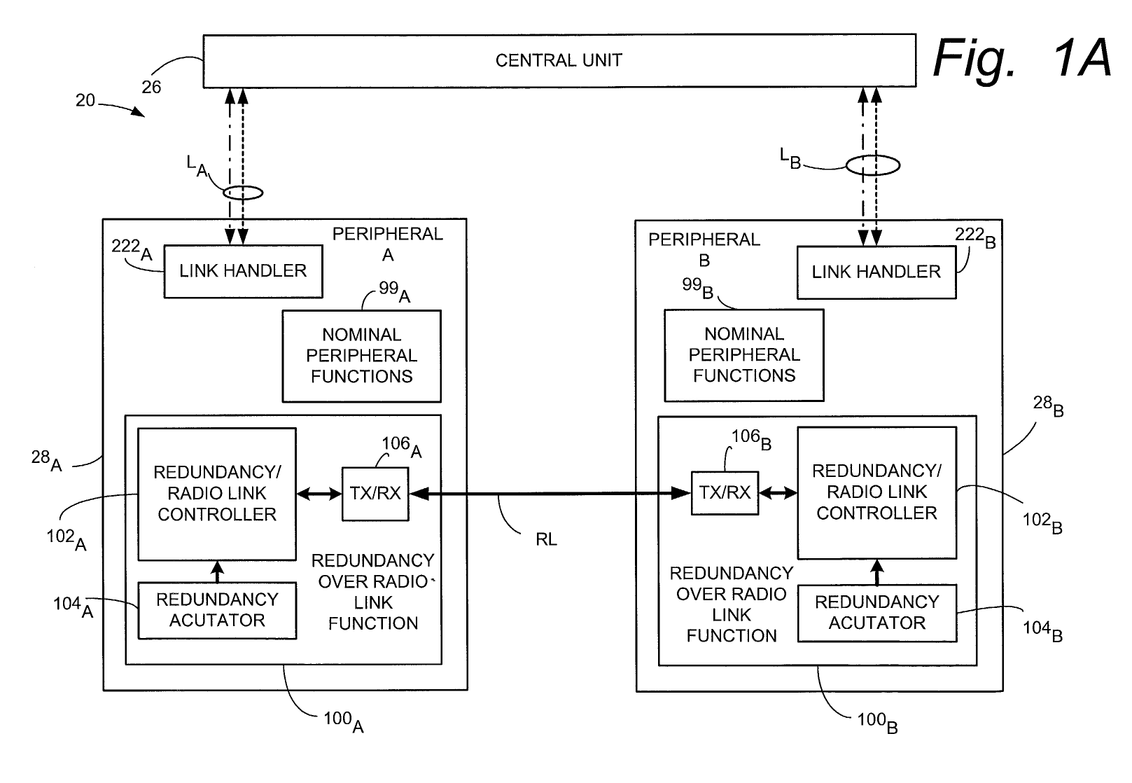

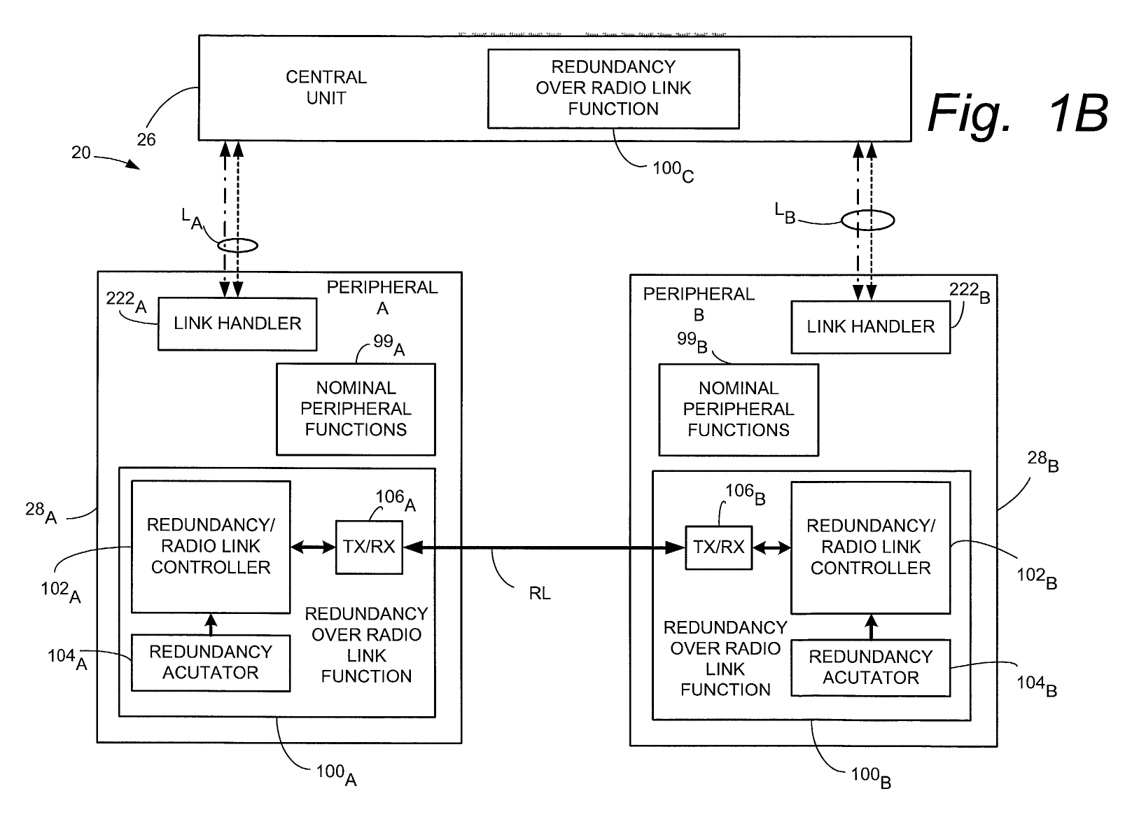

FIG. 1 shows a non-limiting, representative communications network or system 20 which depicts an embodiment of a redundancy capability according to the present invention. The communications network 20 includes a central unit 26 which is connected by various physical links L to respective peripheral units 28 of network 20. For example, central unit 26 is connected by a first physical link L_{A} to a first peripheral unit 28_{A}, and by a second physical link L_{B} to a second peripheral unit 28_{B}, and so forth. Each physical link L in FIG. 1 is illustrated with two lines to signify that a physical link may have or be comprised of plural components. For example, in FIG. 1 each physical link L is shown as comprising a traffic link (depicted by a dotted line) and a control link (depicted by a dash/dotted line). While communications network 20 is shown for sake of simplicity in FIG. 1 as comprising peripheral units 28, it should be understood that the present invention is not constrained or limited by the number of units, and that a greater or lesser number of peripheral units 28 can be included in communications network 20.

Redundancy is realized in communications network 20 of FIG. 1 by providing a radio link RL between a pair of peripheral units 28, so that communication between the central unit 26 and a second of the pair of peripheral units 28 can occur over the radio link RL and via the first peripheral unit 28 of the pair in the event of a failure of or on the link connecting the second peripheral unit 28 and the central unit 26. FIG. 1 shows the radio link RL connecting peripheral unit 28_{A} and peripheral unit 28_{B}, and particularly connecting a redundancy over radio link function 100_{A} of peripheral unit 28_{A} and an admission controller 100_{B} of peripheral unit 28_{B}. While only one radio link is illustrated in FIG. 1, it should be understood that comparable other radio links can be employed to connected peripheral unit 28_{A} to one or more other peripheral units 28, and that various other peripheral units 28 of communications network 20 can likewise be connected together using radio links for redundancy in similar manner as herein described. Thus, while the present discussion primarily is devoted to discussion of provision of redundancy using a radio link RL connecting peripheral unit 28_{A} and peripheral unit 28_{B}, the principles of the invention and the discussion are equally germane to comparably employed radio links employed between other pairs of peripheral units 28.

FIG. 1A shows in more detail some example, basic functionalities or subunits comprising the redundancy over radio link functions 100 according to one embodiment, as well as other general aspects of peripheral unit 28_{A} and peripheral unit 28_{B}, in the context of an example implementation in the communications network 20 of FIG. 1. In addition to having a redundancy over radio link function 100, each peripheral unit 28 has a link handler 222 and certain nominal peripheral functions generally designated by block 99. For example, peripheral unit 28_{A} has a link handler 222_{A} which manages communications with central unit 26 over link L_{A} while peripheral unit 28_{B} has a link handler 222_{B} which manages communications with central unit 26 over link L_{B}.

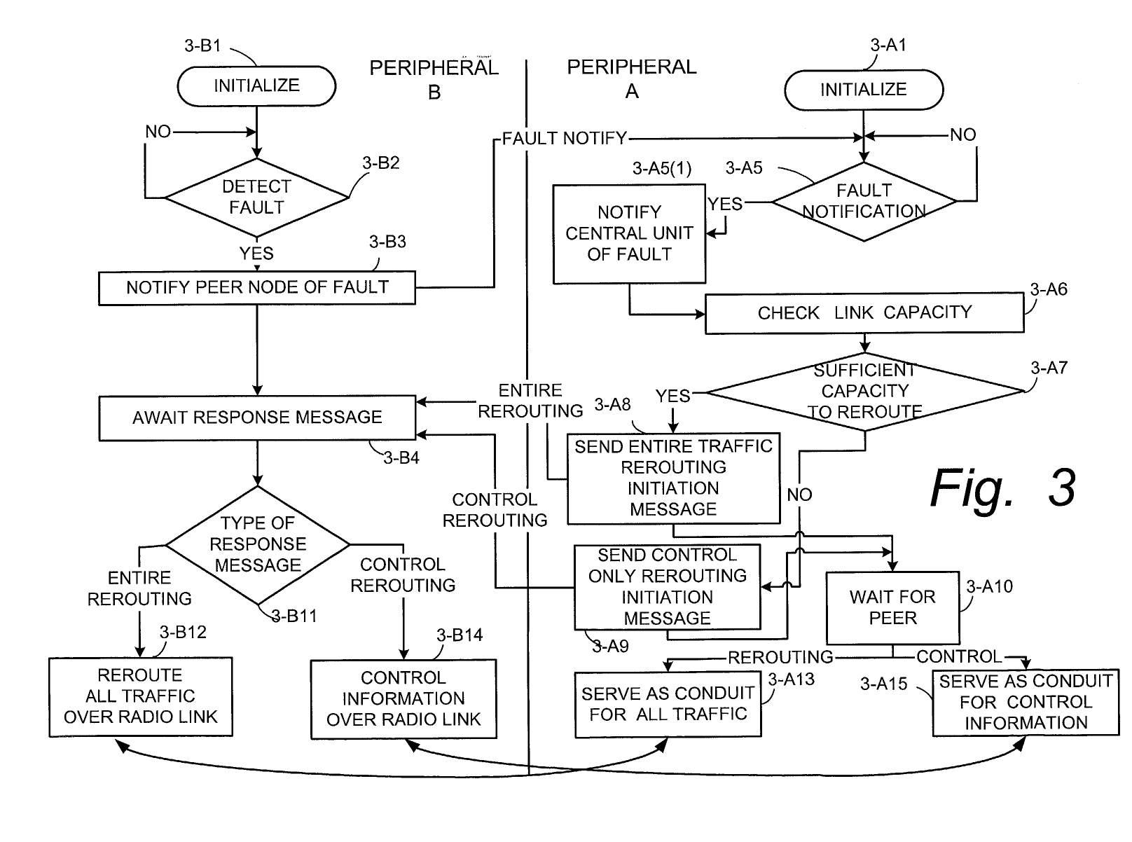

Each redundancy over radio link function 100 in the example embodiment of FIG. 1A comprises a redundancy/radio link controller 102, redundancy actuator 104, and a transmitter/receiver (Tx/Rx) 106 which operates over the radio link RL. For peripheral unit 28_{A}, transmitter/receiver (Tx/Rx) 106_{A} transmits radio communications over the air interface (radio link RL) to peripheral unit 28_{B}, and receives radio communications transmitted by peripheral unit 28_{B} over radio link RL. Actual transmission and reception by redundancy over radio link function 100 is controlled by the redundancy/radio link controller 102 which, among other things, performs basic operations hereinafter described with reference to FIG. 3.

Invocation of the redundancy capability of the present invention, e.g., invocation of redundancy over radio link function 100, is prompted by redundancy actuator 104.

In other words, either upon detection of a failure of link L_{A}, or in response to such failure, redundancy actuator 104_{A} invokes the redundancy over radio link function 100 by, e.g., sending an appropriate signal or message to redundancy/radio link controller 102. While the redundancy actuator 104 is illustrated in FIG. 1A as being a subcomponent or subfunction of redundancy over radio link function 100 in view of the relationship of its operation to other aspects of redundancy over radio link function 100, it should be realized that location of the redundancy actuator 104 and other functionalities shown in FIG. 1A are not limited. For example, in another embodiment redundancy actuator 104 may actually be apart of link handler 222 or of the other nominal peripheral functions 99.

The first peripheral unit (e.g., peripheral unit 28_{A}) and the second peripheral unit (e.g., peripheral unit 28_{B}) are physically separated by a sufficiently small geographical separation distance which makes reasonable the employment of the radio link RL. The geographical separation distance is preferably in a range of from one meters to several kilometers. One technology suitable for establishment of the radio link (in the lower end of the range) is the Bluetooth™ wireless communication technology. The Bluetooth™ wireless communication technology is described, e.g., at www.bluetooth.com.

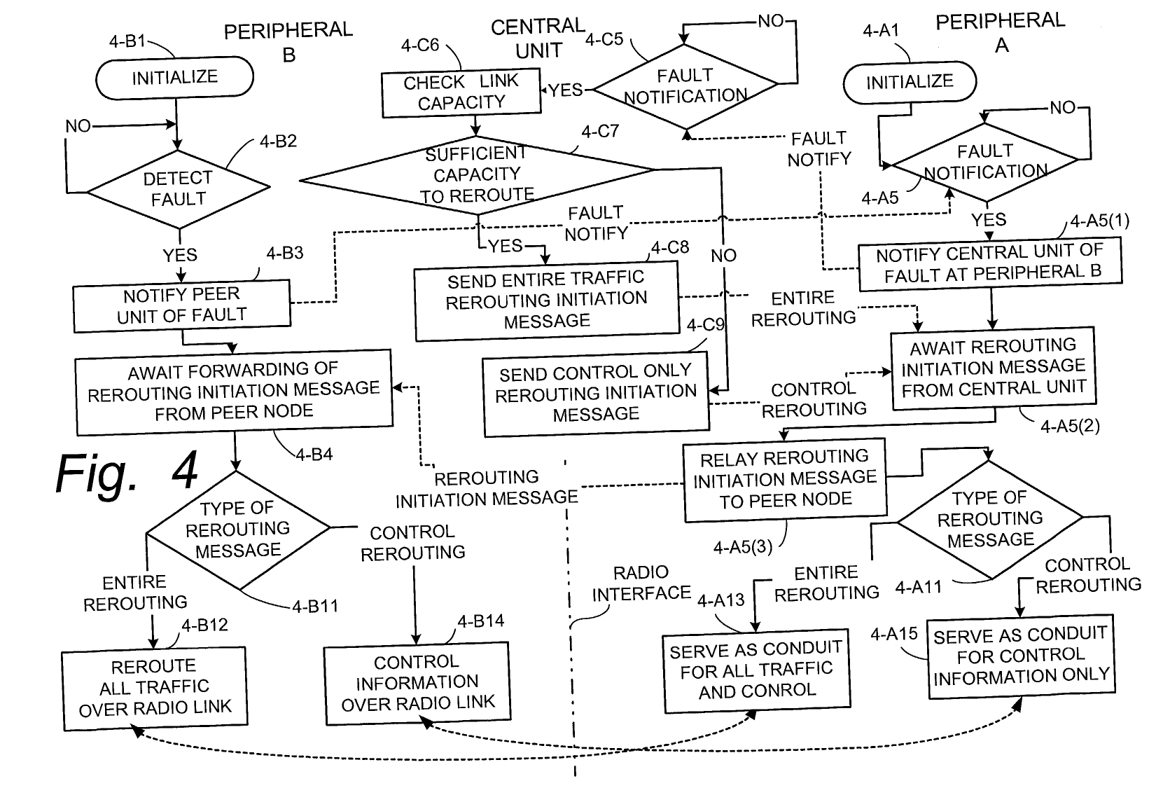

FIG. 1B resembles FIG. 1A, but shows another embodiment which differs from the embodiment of FIG. 1A primarily in that central unit 26 has a redundancy over radio link function 100_{c} which is substantially involved in the redundancy afforded by the invention. Whereas operation of the embodiment of FIG. 1A is hereinafter described with reference to FIG. 3, the operation of the embodiment of FIG. 1B is represented, e.g., by FIG. 4 as subsequently described.

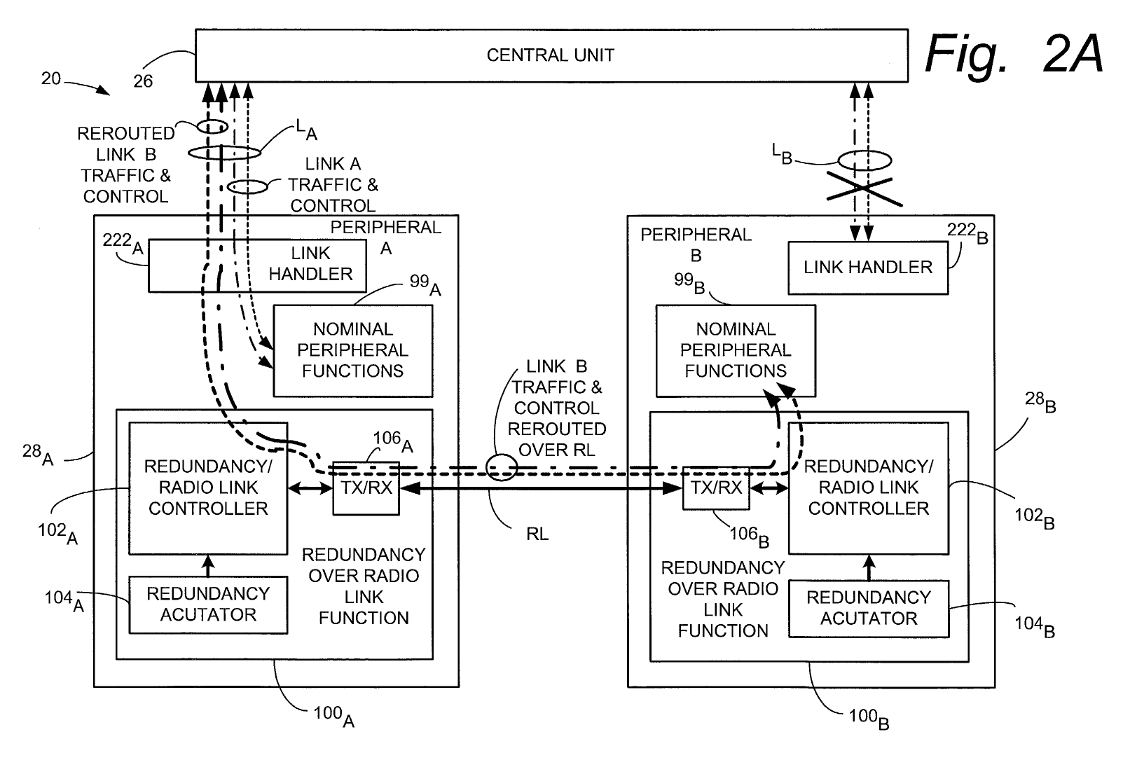

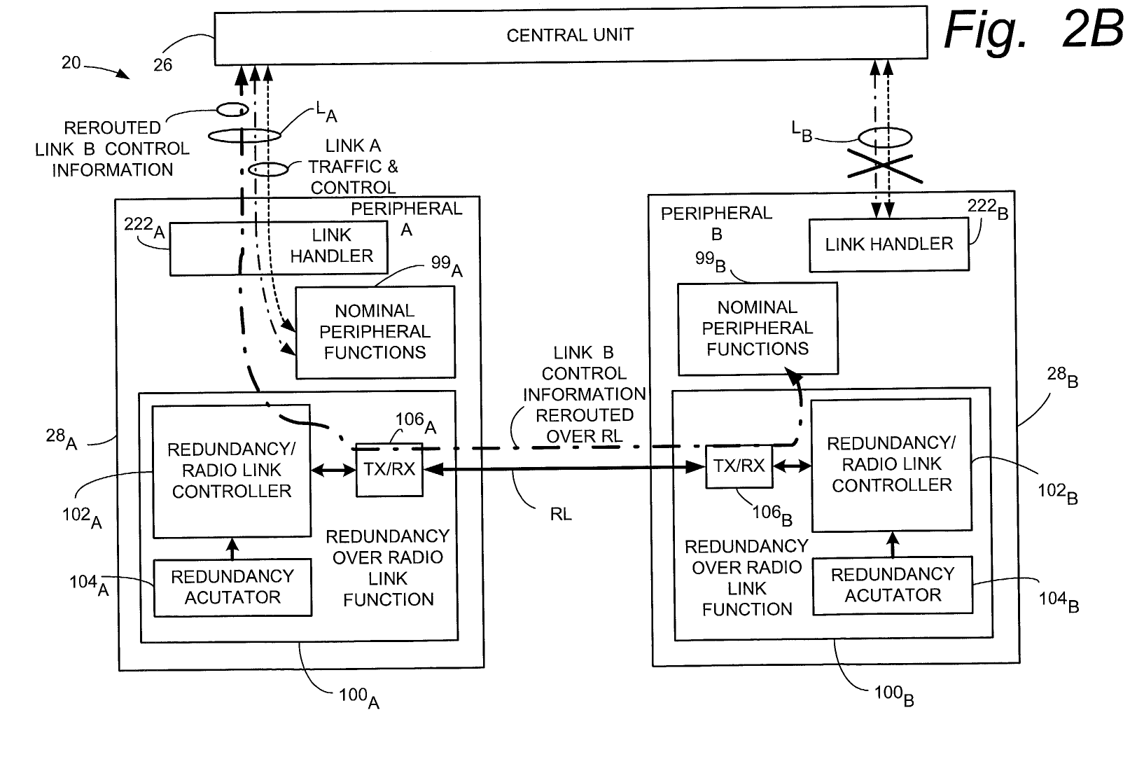

FIG. 2A illustrates an example implementation of a first mode of operation of the invention, in the context of the communications network 20 of FIG. 1A. It will be appreciated that both the FIG. 2A and the FIG. 2B implementation hereinafter described can also occur in the context of the communications network 20 of FIG. 1B. In the FIG. 2A mode, upon failure of physical link L_{B} (as depicted by an “X”ing of physical link L_{B} in FIG. 2A), traffic & control information which otherwise would be carried over the physical link L_{B} between the central unit 26 and the peripheral unit 28_{B} is rerouted to the radio link RL, through peripheral unit 28_{A}, and over the physical link L_{A}. This first mode assumes that the radio link RL and the physical link L_{A} have sufficient capacity to carry the rerouted traffic.

In the FIG. 2B mode of operation, rather than rerouting the entire traffic (e.g., both traffic and all control information), certain control information is carried between the central unit 26 and the peripheral unit 28_{B} over the radio link RL, through peripheral unit 28_{A}, and over the physical link L_{A}. In an example scenario, this control information concerns either the link L_{B} itself (e.g., the status of the second link) or the peripheral unit 28_{B} itself. For example, the control information can be fault localization information concerning failure of the link L_{B} (the failure again being depicted in FIG. 2B by an “X”ing out of link L_{B}).

FIG. 3 and FIG. 4 show certain basic steps preformed in conjunction with the redundancy over radio link capability in two respective example embodiments of the present invention. Subsidiary and incidental steps are not depicted in FIG. 3 and FIG. 4, only such general steps and events as are necessary to convey an understanding of the present invention. As in the preceding discussion of FIG. 1A, FIG. 1B, FIG. 2A, and FIG. 2B, the example of the redundancy over radio link capability demonstrated by FIG. 3 and FIG. 4 occurs in the context of peer peripheral units 28_{A} and 28_{B}, and assumes that the redundancy compensates for a failure of link L_{B} (which connects peripheral unit 28_{B} central unit 26).

In the example scenario of FIG. 3, many operations are performed by the peer peripheral units 28_{A} and 28_{B} over the radio link RL. FIG. 3 has a dashed, double-dotted line, to the left of which appears basic steps performed by a redundancy over radio link function 100_{B} of peripheral unit 28_{B} and to the right of which appears basic steps performed by a redundancy over radio link function 100_{A} of peripheral unit 28_{A}. Moreover, steps performed at node 28_{A} have the format 3-Ax, where x is an integer, while steps performed at node 28_{B} have the format 3-By, where y is an integer. In a sense, the dashed, double-dotted line also represents the radio link RL. Various notifications, signals, messages, and traffic and/or control information transmitted over the radio link RL between the redundancy over radio link functions 100_{A} and 100_{B} of the respective peer peripheral units 28_{A} and 28_{B} are shown by broken lines in FIG. 3.

In the example scenario of FIG. 4, many operations which were performed by the peer peripheral units 28_{A} and 28_{B} over the radio link RL in FIG. 3 are performed instead by the central unit 26. Like FIG. 3, FIG. 4 has a dashed, double-dotted line which similarly represents the radio interface, to the left of which appears basic steps performed by a redundancy over radio link function 100_{B} of peripheral unit 28_{B} and to the right of which appears basic steps performed by a redundancy over radio link function 100_{A} of peripheral unit 28_{A}. Moreover, steps performed at node 28_{A} have the format 4-Ax, where x is an integer, steps performed at node 28_{B} have the format 4-By, where y is an integer; and steps performed by the central unit 26 have the format 4-Cz, where z is an integer.

The steps shown in FIG. 3 and FIG. 4 with respect to peripheral B (e.g., peripheral unit 28_{B}) are only those steps performed when a fault is detected at peripheral B (for example, a failure of link B or some other failure involving peripheral unit 28_{B}). On the other hand, the steps shown in FIG. 3 and FIG. 4 with respect to peripheral A (e.g., peripheral unit 28_{A}) are only those steps performed when peripheral unit 28_{A} is apprised by one of its peer units of a failure affecting that peer unit or that peer unit's link to central unit 26.

It should be understood that the redundancy over radio link function 100_{A} of peripheral unit 28_{A} and redundancy over radio link function 100_{B} of peripheral unit 28_{B} are both suitably prepared or programmed to perform all the steps of FIG. 3 or FIG. 4, e.g., to serve as either a failure detecting node (performing the steps illustrated to the left of the dashed double dotted line of FIG. 3) or as a redundancy-assisting node (performing the steps illustrated to the right of the dashed double dotted line of FIG. 3).

In an example, non-limiting implementation, the logic which results in the performance of the steps of FIG. 3 is primarily resident in the redundancy/radio link controller 102 of the respective peer units. In this regard, the redundancy/radio link controller 102 can be implemented using individual hardware circuits, using software functioning in conjunction with a suitably programmed digital microprocessor or general purpose computer, using an application specific integrated circuit (ASIC), and/or using one or more digital signal processors (DSPs). The steps performed by central unit 26 in the mode of FIG. 4 (e.g., steps including the “C” in the step number) can similarly be implemented by implemented using individual hardware circuits, using software functioning in conjunction with a suitably programmed digital microprocessor or general purpose computer, using an application specific integrated circuit (ASIC), and/or using one or more digital signal processors (DSPs).

Describing in more detail the redundancy over radio link operation of FIG. 3, proper initialization is assumed for both redundancy over radio link function 100_{A} of peripheral unit 28_{A} and redundancy over radio link function 100_{B} of peripheral unit 28_{B} (as represented by steps 3-B1 and 3-A1, respectively). The redundancy operation is initiated (as shown by step 3-B2) by detection of a fault or failure. Such fault or failure is, in the illustrated scenario, a failure of link L_{B} (as indicated by the “X”ing out of link L_{B} in FIG. 2A and FIG. 2B, for example). The fault or failure can be another type of fault, such as a failure at peripheral unit 28_{B}. The failure or fault can be detected by redundancy actuator 104_{B} and communicated, e.g., to redundancy/radio link controller 102_{A}.

Upon the detection of a fault or failure by peripheral unit 28_{B}, as step 3-B3 peripheral unit 28_{B} notifies its peer unit which cooperates in the redundancy over radio link operation, i.e., peripheral unit 28_{A}. In this regard, FIG. 3 shows peripheral unit 28_{B} sending a fault notification to peripheral unit 28_{A} over the radio link RL. The fault notification spawned by step 3-B3 includes an identification of the transmitting node (e.g., an identification of peripheral unit 28_{B}), an indication of the type of message (e.g., fault notification), and information describing the symptoms of the failure (e.g., a perceived failure of link L_{B} in the present example scenario). Other pertinent information can also be sent along with the fault notification generated at step 3-B3, such as (for example) the time of the failure, the amount or character of affected traffic, the identity of affected users, etc. After sending the fault notification to its peer unit 28_{A}, peripheral unit 28_{B} awaits a response from its peer peripheral unit, as shown by step 3-B4.

FIG. 3 illustrates, as step 3-A5, the peripheral unit 28_{A} realizing that it has received a fault notification message from peripheral unit 28_{B}. Upon reception of the fault notification message, as step 3-A5(1) the peripheral unit 28_{A} has the option of sending a fault notification to central node 26. The notification to central node 26 as generated at step 3-A5(1) can include the same types of information as the fault notification generated at step 3-B3. In addition, upon detection of the fault notification message, as step 3-A6 the peripheral unit 28_{A} checks the redundancy capacity of itself and of the link L_{A} which connects peripheral unit 28_{A} to central unit 26. If it is determined at step 3-A7 that peripheral unit 28_{A} and link L_{A} have sufficient capacity and ability to accommodate a rerouting of the entire traffic formerly handled by link L_{B}, as step 3-A8 the peripheral unit 28_{A} sends an entire traffic rerouting initiation message to peripheral unit 28_{B} over radio link RL. Otherwise, as step 3-A9 the peripheral unit 28_{A} sends a control only rerouting initiation message to peripheral unit 28_{B} over radio link RL. After transmission of either the entire traffic rerouting initiation message of step 3-A8 or the control only rerouting initiation message of step 3-A9, the peripheral unit 28_{A} awaits further communication from peripheral unit 28_{B} as depicted by step 3-A10.

Upon receiving from peripheral unit 28_{A} one of the entire traffic rerouting initiation (see step 3-A8) or the control only rerouting initiation message (see step 3-A9), the peripheral unit 28_{B} exits its waiting step 3-B4 and, at step 3-B11, determines the type of response message received from peripheral unit 28_{A}.

If the response message is the entire traffic rerouting permission message, as step 3-B12 peripheral unit 28_{B} commences and conducts efforts to reroute all traffic and control (formerly handled by link L_{B}) over the radio link RL, through peripheral unit 28_{A}, and over link L_{A} to central unit 26, so that all bidirectional communication between peripheral unit 28_{B} and central unit 26 is restored as a result of the redundancy. Step 3-A13 shows peripheral unit 28_{A} (and thus link L_{A}) serving as a conduit for all traffic and control information which is rerouted. Rerouting of all traffic and control formerly handled by link L_{B} over radio link RL, through peripheral unit 28_{A}, and over link L_{A} to central unit 26 is shown in the example of FIG. 2A.

On the other hand, if the response message is the control only rerouting initiation message, as step 3-B14 peripheral unit 28_{B} commences and conducts efforts to transmit only control information (formerly handled by link L_{B}) over the radio link RL, through peripheral unit 28_{A}, and over link L_{A} to central unit 26, so that all bidirectional control information between peripheral unit 28_{B} and central unit 26 continues to be transmitted as a result of the redundancy. Step 3-A15 shows peripheral unit 28_{A} (and thus link L_{A}) serving as a conduit for all control information which is rerouted. Rerouting of control information formerly handled by link L_{B} over radio link RL, through peripheral unit 28_{A}, and over link L_{A} to central unit 26 is shown in the example of FIG. 2B. The control information can concern, for example, either the second link (e.g., the status of the second link) or the second peripheral unit itself. For example, the control information can be fault localization information concerning failure of the second link.

As mentioned above, the example scenario of FIG. 4 differs from that of FIG. 3 primarily in that various operations which were performed by the peer peripheral units 28_{A} and 28_{B} over the radio link RL in FIG. 3 are performed instead by the central unit 26 in FIG. 4. In this scenario the function of the central unit could be implemented in any higher network layer node or they could be shared between more than one network node from different network layers, as such implementations are within the operating principle of the present invention.

As in the FIG. 3 scenario, the FIG. 4 scenario assumes proper initialization of both redundancy over radio link function 100_{A} of peripheral unit 28_{A} and redundancy over radio link function 100_{B} of peripheral unit 28_{B} (as represented by steps 4-B1 and 4-A1, respectively). The redundancy operation is initiated (as shown by step 4-B2) by detection of a fault or failure. Such fault or failure is (again) a failure of link L_{B} (as indicated by the “X”ing out of link L_{B} in FIG. 2A and FIG. 2B, for example).

Upon the detection of a fault or failure by peripheral unit 28_{B}, as step 4-B3 peripheral unit 28_{B} notifies peer peripheral unit 28_{A} of the fault. FIG. 4 shows peripheral unit 28_{B} sending a fault notify message to peer peripheral unit 28_{A}. The fault notification spawned by step 4-B3 includes the same type of information previously described in connection with step 3-B3 of FIG. 3. After sending the fault notification to its peer unit 28_{A}, peripheral unit 28_{B} awaits a response message from its peer unit (e.g., peripheral unit 28_{A}), as shown by step 4-B4.

FIG. 4 illustrates, as step 4-A5, the peripheral unit 28_{A} realizes that it has received a fault notification message from peripheral unit 28_{B}. Upon reception of the fault notification message, as step 4-A5(1) the peripheral unit 28_{A} sends a fault notification message to central unit 26. The fault notification message is generated as step 4-A5(1) and sent to central unit 26 advises of the fault experienced by peripheral unit 28_{B}, and can provide essentially the same type of information as peripheral unit 28_{B} has provided to peripheral unit 28_{A}. After notifying central unit 26 of the fault, as step 4-A5(2) the peripheral unit 28_{A} awaits further direction from central unit 26, e.g., peripheral unit 28_{A} awaits receipt of a rerouting initiation message from central unit 26.

In the FIG. 4 embodiment, the central unit 26 has a process which monitors for receipt of fault notifications from the peripheral units and supervises the redundancy over the radio link. The beginning of such process is reflected by step 4-C5, which shows central unit 26 periodically determining whether it has received a fault notification. In the event that a fault notification is received [such as the fault notification generated at step 4-A5(1)], as step 4-C6 central unit 26 checks the redundancy capacity of peripheral unit 28_{A} and of the link L_{A} which connects peripheral unit 28_{A} to central unit 26. If it is determined at step 4-C7 that peripheral unit 28_{A} and link L_{A} have sufficient capacity and ability to accommodate a rerouting of the entire traffic formerly handled by link L_{B}, as step 4-C8 central unit 26 sends an entire traffic rerouting initiation message to peripheral unit 28_{A} over physical link L_{A}. Otherwise, as step 4-C9 central unit 26 sends a control only rerouting initiation message to peripheral unit 28_{A} over physical link L_{A}. After transmission of either the entire traffic rerouting initiation message of step 4-C8 or the control only rerouting initiation message of step 4-C9, central unit 26 typically performs other unillustrated functions. Such other functions include, for example, subsequent and periodic monitoring of the traffic conditions over the link L_{A} (since link L_{A} will carry the rerouted traffic and/or control information between peripheral unit 28_{B} and central unit 26, in addition to its usual traffic). In addition, central unit 26 eventually discontinues the rerouting, e.g., when the rerouting is no longer feasible or necessary (e.g., upon detecting repair of the fault or failure).

Upon receiving from central unit 26 one of the entire traffic rerouting initiation (see step 4-C8) or the control only rerouting initiation message (see step 4-C9), the peripheral unit 28_{A} exits its waiting step 4-A5(2). As step 4-A5(3), peripheral unit 28_{A} essentially forwards the contents of the rerouting initiation message received from central unit 26 (e.g., either the entire traffic rerouting initiation message or the control only rerouting initiation message) to peripheral unit 28_{B} over the radio link RL.

As step 4-A11, peripheral unit 28_{A} determines the type of rerouting initiation message received from central unit 26. Similarly, in analogous manner as step 4B-11, peripheral unit 28_{B} determines the type of rerouting initiation message originated by central unit 26 and forwarded by 28a and forwarded by peripheral unit 28_{A}. If the rerouting initiation message is the entire traffic rerouting initiation message, as step 4-B12 peripheral unit 28_{B} commences and conducts efforts to reroute all traffic and control (formerly handled by link L_{B}) over the radio link RL, through peripheral unit 28_{A}, and over link L_{A} to central unit 26, so that all bidirectional communication between peripheral unit 28_{B} and central unit 26 is restored as a result of the redundancy. Step 4-A13 shows peripheral unit 28_{A} (and thus link L_{A}) serving as a conduit for all traffic and control information which is rerouted. Rerouting of all traffic and control formerly handled by link L_{B} over radio link RL, through peripheral unit 28_{A}, and over link L_{A} to central unit 26 is shown in the example of FIG. 2A.

On the other hand, if the rerouting initiation message received at step 4-B11 is control only rerouting initiation message, as step 4-B14 peripheral unit 28_{B} commences and conducts efforts to transmit only control information (formerly handled by link L_{B}) over the radio link RL, through peripheral unit 28_{A}, and over link L_{A} to central unit 26, so that all bidirectional control information between peripheral unit 28_{B} and central unit 26 continues to be transmitted as a result of the redundancy. Step 4-A15 shows peripheral unit 28_{A} (and thus link L_{A}) serving as a conduit for all control information which is rerouted. Rerouting of control information formerly handled by link L_{B} over radio link RL, through peripheral unit 28_{A}, and over link L_{A} to central unit 26 is shown in the example of FIG. 2B. The control information can concern, for example, either the second link (e.g., the status of the second link) or the second peripheral unit itself. For example, the control information can be fault localization information concerning failure of the second link.

In some respects, the embodiment of FIG. 4 has enhanced efficiency. For example, the functionality illustrated by the step 4C6 in FIG. 4 need be implemented only once in central unit 26, and not in each peripheral unit. Other advantages are also realized.

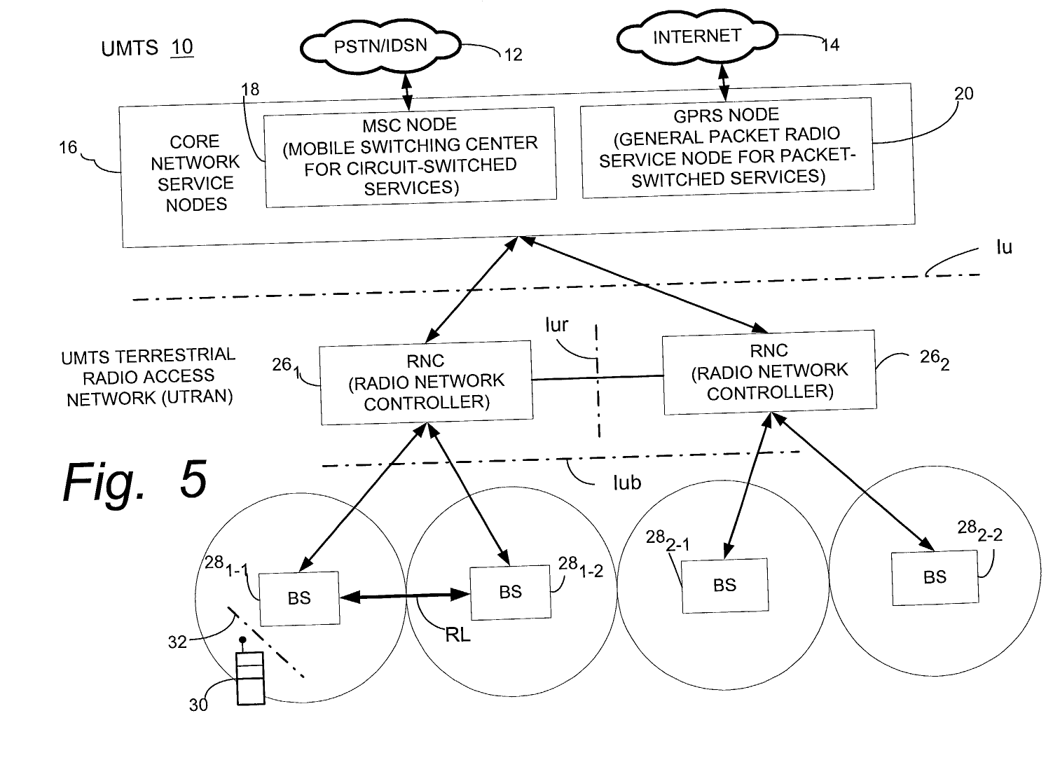

In one illustrated example implementation, the communications network is a radio access network of a telecommunications system, with the central unit being a radio network control (RNC) node and the first peripheral unit and the second peripheral unit being differing base stations of the radio access network. Such implementation is illustrated basically by the universal mobile telecommunications (UMTS) 10 shown in FIG. 5. In FIG. 5, a representative, connection-oriented, external core network, shown as a cloud 12 may be for example the Public Switched Telephone Network (PSTN) and/or the Integrated Services Digital Network (ISDN). A representative, connectionless-oriented external core network shown as a cloud 14, may be for example the Internet. Both core networks are coupled to their corresponding service nodes 16. The PSTN/ISDN connection-oriented network 12 is connected to a connection-oriented service node shown as a Mobile Switching Center (MSC) node 18 that provides circuit-switched services. The Internet connectionless-oriented network 14 is connected to a General Packet Radio Service (GPRS) node 20 tailored to provide packet-switched type services which is sometimes referred to as the serving GPRS service node (SGSN).

Each of the core network service nodes 18 and 20 connects to a UMTS Terrestrial Radio Access Network (UTRAN) 24 over a radio access network (RAN) interface referred to as the Iu interface. UTRAN 24 includes one or more radio network controllers (RNCs) 26. For sake of simplicity, the UTRAN 24 of FIG. 5 is shown with only two RNC nodes, particularly RNC 26₁ and RNC26₂. Each RNC 26 is connected to a plurality of base stations (BS) 28. For example, and again for sake of simplicity, two base station nodes are shown connected to each RNC 26. In this regard, RNC 26₁ serves base station 28₁₋₁ and base station 28₁₋₂, while RNC 26₂ serves base station 28₂₋₁ and base station 28₂₋₂. It will be appreciated that a different number of base stations can be served by each RNC, and that RNCs need not serve the same number of base stations. Moreover, FIG. 5 shows that an RNC can be connected over an Iur interface to one or more other RNCs in the URAN 24.

In the illustrated embodiments, for sake of simplicity each base station 28 is shown as serving one cell. Each cell is represented by a circle which surrounds the respective base station. It will be appreciated by those skilled in the art, however, that a base station may serve for communicating across the air interface for more than one cell. For example, two cells may utilize resources situated at the same base station site.

A user equipment unit (UE), such as user equipment unit (UE) 30 shown in FIG. 5, communicates with one or more cells or one or more base stations (BS) 28 over a radio or air interface 32. Each of the radio interface 32, the Iu interface, the Iub interface, and the Iur interface are shown by dash-dotted lines in FIG. 5.

It will be appreciated, therefore, that the radio network controller (RNC) node of FIG. 5 can serve as the central unit 26 aforedescribed, while the base station (BS) nodes 28 of FIG. 5 can serve as the peripheral units 28. In this regard, note the example radio link RL shown in FIG. 5 as connecting base station 28₁₋₁ and base station 28₁₋₂. Where appropriate, other base stations can also be connected by radio links for achieving the redundancy over radio link capability herein described.

Preferably, in the network of FIG. 5 radio access is based upon wideband, Code Division Multiple Access (WCDMA) with individual radio channels allocated using CDMA spreading codes. Of course, other access methods may be employed. WCDMA provides wide bandwidth for multimedia services and other high transmission rate demands as well as robust features like diversity handoff and RAKE receivers to ensure high quality. Each user mobile station or equipment unit (UE) 30 is assigned its own scrambling code in order for a base station 28 to identify transmissions from that particular user equipment unit (UE) as well as for the user equipment unit (UE) to identify transmissions from the base station intended for that user equipment unit (UE) from all of the other transmissions and noise present in the same area.

Different types of control channels may exist between one of the base stations 28 and user equipment units (UEs) 30. For example, in the forward or downlink direction, there are several types of broadcast channels including a general broadcast channel (BCH), a paging channel (PCH), a common pilot channel (CPICH), and a forward access channel (FACH) for providing various other types of control messages to user equipment units (UEs). In the reverse or uplink direction, a random access channel (RACH) is employed by user equipment units (UEs) whenever access is desired to perform location registration, call origination, page response, and other types of access operations. The random access channel (RACH) is also used for carrying certain user data, e.g., best effort packet data for, e.g., web browser applications.

As set up by the control channels, traffic channels (TCH) are allocated to carry substantive call communications with a user equipment unit (UE). Some of the traffic channels can be common traffic channels, while others of the traffic channels can be dedicated traffic channels (DCHs).

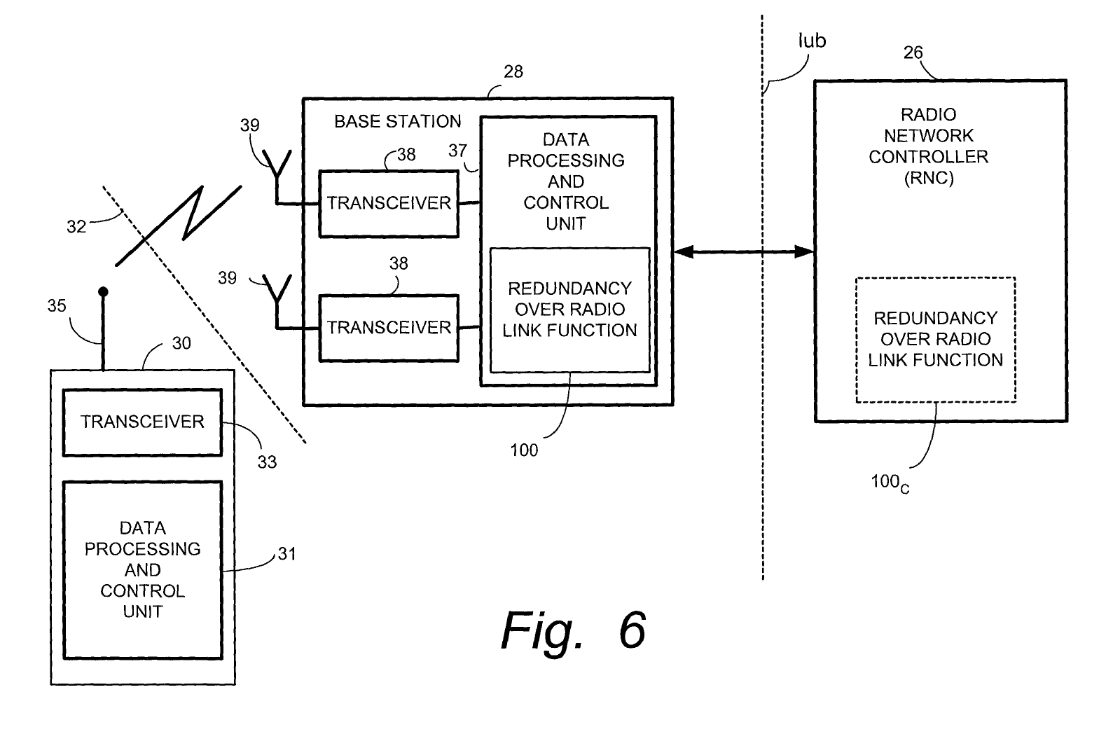

FIG. 6 shows selected general aspects of user equipment unit (UE) 30 and illustrative nodes such as radio network controller 26 (e.g., central unit 26) and a base station 28 (e.g., one of the peripheral units 28). The user equipment unit (UE) 30 shown in FIG. 6 includes a data processing and control unit 31 for controlling various operations required by the user equipment unit (UE). The UE's data processing and control unit 31 provides control signals as well as data to a radio transceiver 33 connected to an antenna 35.

The example radio network controller 26 and base station 28 as shown in FIG. 6 are radio network nodes that each include a corresponding data processing and control unit 36 and 37, respectively, for performing numerous radio and data processing operations required to conduct communications between the RNC 26 and the user equipment units (UEs) 30. Part of the equipment controlled by the base station data processing and control unit 37 includes plural radio transceivers 38 connected to one or more antennas 39. In addition, the base station data processing and control unit 37 includes the redundancy over radio link function 100 operation having an operation previously described. For the FIG. 1B and FIG. 4 embodiments, the redundancy over radio link function 100_{C} in the radio network controller 26 (e.g., central unit 26) is depicted in broken lines as being resident in data processing and control unit 36.

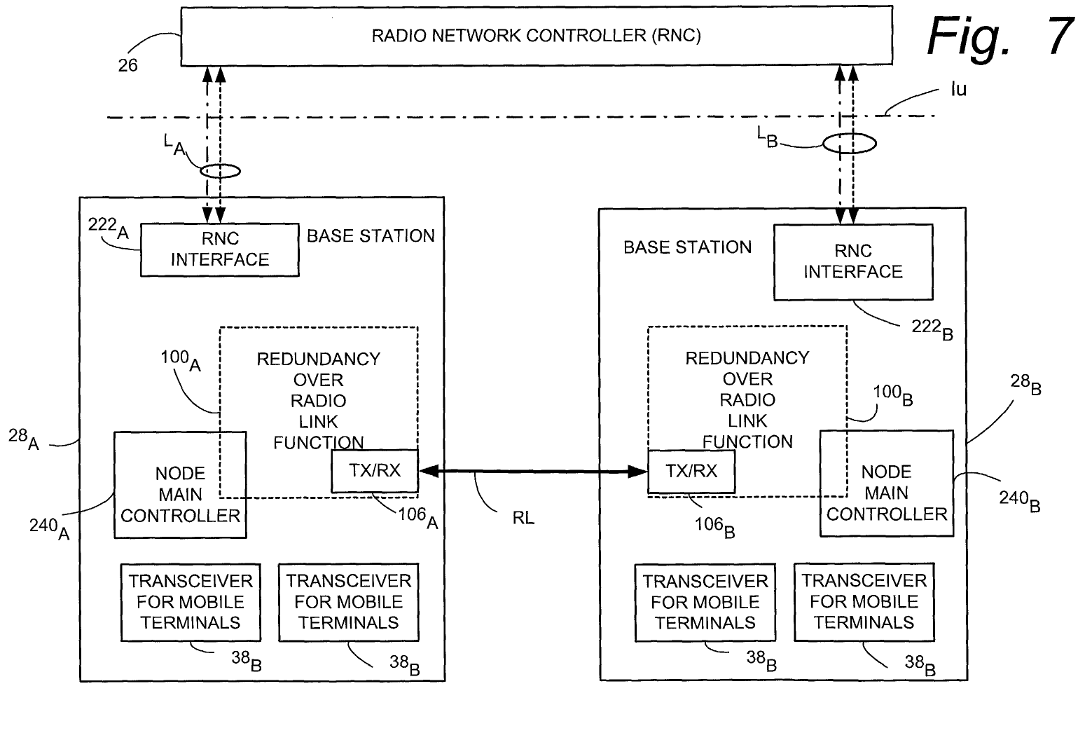

FIG. 7 shows an example utilization of a redundancy over radio link function of FIG. 1A in context of the network 20 of FIG. 2. In FIG. 7, the link handlers 222 take the form of RNC interfaces. In view of the fact that the base stations 28 communicates over the air interface with user equipment units (UEs) or mobile terminals, one or more transceivers for mobile terminals 38 are shown for each of base station 28_{A} and 28_{B}. The number of such transceivers for mobile terminals 38 is not critical to the present invention, for which reason and sake of simplicity only two such transceivers 38 are shown for each of base station 28_{A} and 28_{B} in FIG. 7. FIG. 7 further shows that, in this particular embodiment, the activities of the redundancy over radio link function 100 for each base station are realized and performed by a node main controller 240 and radio link transmitter/receiver (Tx/Rx) 106. In the implementation of FIG. 7, an example of a fault or failure which can occur at base station 28_{B} and prompt utilization of the radio link redundancy of the present invention is a fault occurring in hardware or software at the RNC interface 222_{B}.

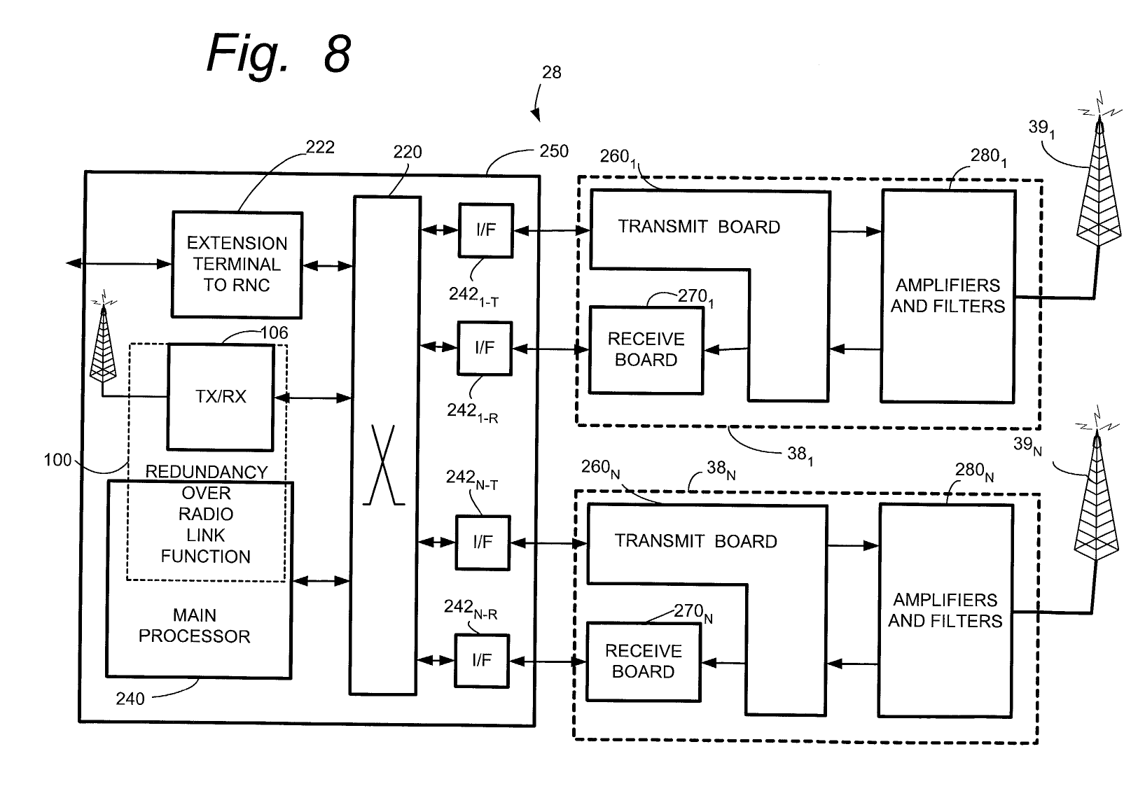

FIG. 8 illustrates, in non-limiting manner, more details of an example base station (BS) node 28 in accordance with one embodiment of the present invention. As with RNC node 26, the base station (BS) node 28 of FIG. 8 is a switched-based node having a switch 220 which serves to interconnect other constituent elements of base station (BS) node 28. Such other constituent elements include extension terminal 222; ALT unit 228; BS main processor 240; interface boards 242; and, transmitter/receiver (Tx/Rx) 106.

Extension terminal 222 connects base station (BS) node 28 to radio network controller (RNC) node 26, and thus comprises the Iub interface. The embodiment of base station (BS) node 28 illustrated in FIG. 8 is housed in a rack having multiple subracks. Each subrack has one or more boards, e.g., circuit boards, mounted thereon. A first subrack 250 contains boards for each of extension terminal 222; ALT unit 228; BS main processor 240, and interface boards 242. Each of the interface boards 242 is connected to a board on another subrack, e.g., one of the transmitter boards 260 or one of the receiver boards 270. Each receiver board 270 is connected to share certain transmitter/receiver resources in a corresponding transmitter board 260, with the transmitter board 260 being connected to a corresponding one of amplifiers and filters board 280. The amplifiers and filters board 280 is connected to an appropriate antenna 39. For example, interface board 242_{1-T} is connected to transmitter board 260₁, while interface board 242_{1-R} is connected to receiver board 270₁. The pair of transmitter board 260₁ and receiver board 270₁ is, in turn, connected to amplifiers and filters board 280₁. Similar connections exist for a second pairing of transmitter board 260₂ and receiver board 270₂, which interface via interface board 242_{2-T} and interface board 242_{2-R}, respectively. Each transceiver 38 of FIG. 6 thus comprises a subrack which includes a transmitter board 260, a receiver board 270, and amplifiers and filters board 280.

In one example embodiment, base station (BS) node 28 is an ATM-based node, with interface boards 242 performing various ATM interfacing functions. The transmitter boards 260 and receiver boards 270 each include several devices. For example, each transmitter board 260 includes unillustrated elements such as an interface connected to its corresponding interface board 242; an encoder; a modulator; and, a baseband transmitter. In addition, the transmitter board 260 includes the transmitter/receiver sources which it shares with receiver board 270, including a radio frequency transmitter. Each receiver board 270 includes unillustrated elements such as an interface connected to its corresponding interface board 242; a decoder; a demodulator; and, a baseband receiver. Each amplifiers and filters board 280 includes amplifiers, such as MCPA and LNA amplifiers.

In the example base station (BS) node 28 of FIG. 8, BS main processor 240 which performs the functions of redundancy/radio link controller 102.

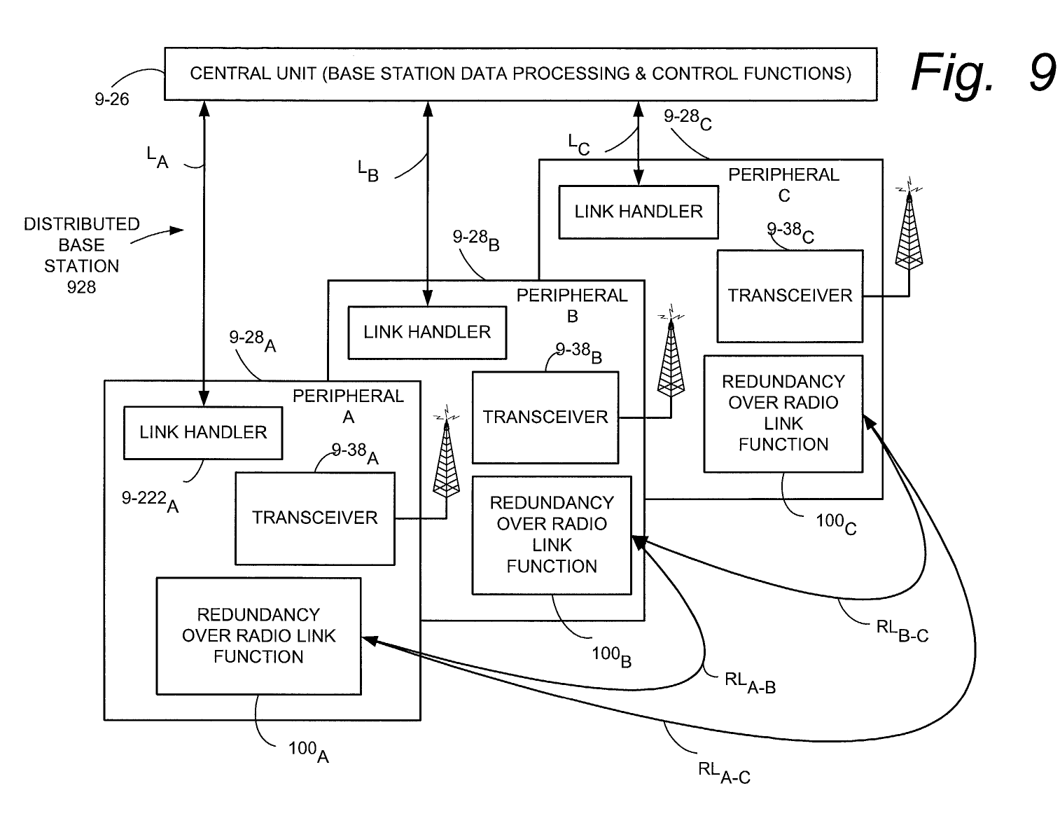

In the example embodiment of FIG. 9, the central unit and the peripherals unit comprise portions of a distributed radio base station node 928 of a radio access telecommunications network. The central unit 9-26 comprises data processing and control functions of the distributed radio base station node 928, while the plural peripheral units 9-28 each comprises a transceiver 9-38 of the distributed radio base station node 928. While FIG. 9 shows three such plural peripheral units 9-28_{A}-9-28_{C}, it should be understood that the present invention is not constrained by any particular number of peripheral units 9-28. The peripheral units 9-28 have their respective redundancy over radio link functions 100 connected by radio links RL. For example, peripheral unit 9-28_{A} is connected to peripheral unit 9-28_{B} over radio link RL_{A-B} and to peripheral unit 9-28_{C} over radio link RL_{A-C}; peripheral unit 9-28_{B} is connected to peripheral unit 9-28_{A} over radio link RL_{A-B} and to peripheral unit 9-28_{C} over radio link RL_{B-C}; and, peripheral unit 9-28_{C} is connected to peripheral unit 9-28_{A} over radio link RL_{A-C} and to peripheral unit 9-28_{B} over radio link RL_{B-C}. The transceivers 38 depicted in FIG. 9 can be transceivers such as those generically shown as transceiver 38 in FIG. 8, for example. The operation of the distributed radio base station node 928 of FIG. 9 is understood from the preceding description of the operation of various modes of the present invention.

As mentioned above, the function of the central unit could be implemented in various manners. For example, with reference to FIG. 9, the central unit could be situated either entirely in a radio network controller (RNC) node, e.g., any network layer node higher than the peripheral unit or even shared between more than one network nodes from different network layers. Alternatively, the central unit can be distributed to reside partially in a node such as the radio network controller (RNC) node and a radio base station (RBS) node.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A communications network comprising a central unit, a first peripheral unit, and a second peripheral unit; the central unit being connected by a first link to the first peripheral unit and by a second link to the second peripheral unit, the communications network further comprising:
means for providing a radio link between the first peripheral unit and the second peripheral unit;
means for providing communication between the central unit and the second peripheral unit over the radio link upon failure of the second link.

2. The apparatus of claim 1, wherein the means for providing communication reroutes traffic carried over the second link to the radio link and the first link.

3. The apparatus of claim 1, wherein the means for providing communication provides control information concerning one of the second link and the second peripheral unit to the radio link and the first link.

4. The apparatus of claim 3, wherein the means for providing communication provides fault localization information concerning failure of the second link to the radio link and the first link.

5. The apparatus of claim 1, wherein one of (1) the central unit, and (2) the first peripheral unit determine whether traffic and/or control information is to be rerouted from the second link to the first link.

6. The apparatus of claim 1, wherein the central unit, the first peripheral unit, and the second peripheral unit are each nodes of the communications network.

7. The apparatus of claim 1, wherein the communications network is a radio access telecommunications network, wherein the central unit is a radio network control (RNC) node; wherein the first peripheral unit is a first base station; and wherein the second peripheral unit is a second base station.

8. The apparatus of claim 1, wherein the central unit, the first peripheral unit, and the second peripheral unit comprise portions of a distributed radio base station node of a radio access telecommunications network.

9. The apparatus of claim 8, wherein the central unit comprises data processing and control functions of the distributed radio base station node, and wherein at least one of the first peripheral unit and the second peripheral unit comprises a transceiver of the distributed radio base station node.

10. A communications network comprising:
a central unit;
a first peripheral unit;
a second peripheral unit;
a first link which connects the central unit to the first peripheral unit;
a second link which connects the central unit to the second peripheral unit,
a radio link connecting the first peripheral unit and the second peripheral unit;
wherein communication occurs between the central unit and the second peripheral unit over the radio link upon failure of the second link.

11. The apparatus of claim 10, wherein rerouting of traffic carried over the second link to the radio link and the first link occurs upon failure of the second link.

12. The apparatus of claim 10, wherein control information concerning one of the second link and the second peripheral unit is carried over the second link to the radio link and the first link occurs upon failure of the second link.

13. The apparatus of claim 10, wherein the control information is fault localization information concerning failure of the second link.

14. The apparatus of claim 10, wherein one of (1) the central unit, and (2) the first peripheral unit determine whether traffic and/or control information is to be rerouted from the second link to the first link.

15. The apparatus of claim 10, wherein the central unit, the first peripheral unit, and the second peripheral unit are each nodes of the communications network.

16. The apparatus of claim 15, wherein the communications network is a radio access telecommunications network, wherein the central unit is a radio network control (RNC) node; wherein the first peripheral unit is a first base station; and wherein the second peripheral unit is a second base station.

17. The apparatus of claim 10, wherein the central unit, the first peripheral unit, and the second peripheral unit comprise portions of a distributed radio base station node of a radio access telecommunications network.

18. The apparatus of claim 17, wherein the central unit comprises data processing and control functions of the distributed radio base station node, and wherein at least one of the first peripheral unit and the second peripheral unit comprises a transceiver of the distributed radio base station node.

19. A peripheral unit for use in a communications network which also includes a central unit and another peripheral unit, the central unit being connected by a first link to the another peripheral unit and by a second link to the peripheral unit, the peripheral unit comprising means for communicating with the central unit over a radio link upon failure of the second link, the radio link being established between the peripheral unit and the another peripheral unit.

20. The apparatus of claim 19, wherein the means for communicating reroutes traffic carried over the second link to the radio link and the first link.

21. The apparatus of claim 19, wherein the means for communicating provides control information concerning one of the second link and the peripheral unit to the radio link and the first link.

22. The apparatus of claim 21, wherein the means for communicating provides fault localization information concerning failure of the second link to the radio link and the first link.

23. The apparatus of claim 19, wherein the peripheral unit is a base station of a radio access telecommunications network.

24. The apparatus of claim 19, wherein the central unit, the first peripheral unit, and the second peripheral unit comprise portions of a distributed radio base station node of a radio access telecommunications network.

25. The apparatus of claim 24, wherein the central unit comprises data processing and control functions of the distributed radio base station node, and wherein at least one of the first peripheral unit and the second peripheral unit comprises a transceiver of the distributed radio base station node.

26. For use in a communications network comprising a central unit, a first peripheral unit, and a second peripheral unit; the central unit being connected by a first link to the first peripheral unit and by a second link to the second peripheral unit, a method comprising:
providing communication between the central unit and the second peripheral unit over a radio link upon failure of the second link, the radio link extending between the first peripheral unit and the second peripheral unit.

27. The method of claim 26, wherein the step of providing communication comprises rerouting traffic carried over the second link to the radio link and the first link.

28. The method of claim 26, wherein the step of providing communication comprises providing control information concerning one of the second link and the second peripheral unit to the radio link and the first link.

29. The method of claim 28, wherein the step of providing control information comprises providing fault localization information concerning failure of the second link to the radio link and the first link.

30. The method of claim 26, wherein the central unit, the first peripheral unit, and the second peripheral unit are each nodes of the communications network.

31. The method of claim 30, wherein the communications network is a radio access telecommunications network, wherein the central unit is a radio network control (RNC) node; wherein the first peripheral unit is a first base station; and wherein the second peripheral unit is a second base station.

32. The method of claim 26, wherein the central unit, the first peripheral unit, and the second peripheral unit comprise portions of a distributed radio base station node of a radio access telecommunications network.

33. The method of claim 32, wherein the central unit comprises data processing and control functions of the distributed radio base station node, and wherein at least one of the first peripheral unit and the second peripheral unit comprises a transceiver of the distributed radio base station node.

34. The method of claim 26, further comprising the central unit determining whether traffic and/or control information is to be rerouted from the second link to the first link.

35. The method of claim 26, further comprising the first peripheral unit determining whether traffic and/or control information is to be rerouted from the second link to the first link.
